(19) United States
(12) Patent Application Publication
(10) Pub. No.: US 2009/0128358 A1
(43) Pub. Date: May 21, 2009

(54) Identification System

(76) Inventor: Eran Tuval, Moshav Cahal (IL)

Correspondence Address: THE NATH LAW GROUP, 112 South West Street, Alexandria, VA, 22314, US

(21) Appl. No.: 11/884,847

(22) PCT Filed: Feb. 26, 2006
(86) PCT No.: PCT/IL2006/000252

§ 371 Date: Nov. 30, 2007

(30) Foreign Application Priority Data
Feb. 24, 2005 (IL) 167110

(51) Int. Cl. G08B 5/22; G08B 13/14

(52) U.S. Cl. 340/825.49; 340/572.1

(57) ABSTRACT

A system and method for identification of a plurality of movable objects, such as animals entering a milking or feeding stall. The system includes a plurality of activators, each activator being in a fixed location and capable of generating a unique first identification signal. The system also includes a plurality of identification tags, each tag being adapted to be attached to one of the movable objects and capable of generating a unique second identification signal. An identification module is used to receive from each activator an identification signal and to transmit to a processor a first transmitted signal indicative of an identification of the activator. The identification module is also used to receive a identification signal of a tag adjacent to each activator and to transmit to the processing unit a signal indicative of an identification of the tag. The processor is configured, for each pair of a first transmitted signal and a second transmitted signal received from the identification module, to associate the identification of the activator with the identification of the tag and to store the identification of the activator and the identification of the tag in the memory.

### FIELD OF THE INVENTION

This invention relates to communications systems and more specifically to such systems for reading electronic identification.

### BACKGROUND OF THE INVENTION

Identification systems are used in order to identify or locate movable objects. Such systems are used, for example, to follow the movement of merchandise in a store in order to prevent shoplifting. These systems are also used to identify livestock in a milking or feeding parlor.

In one type of identification system, a tag is affixed to each of a plurality of movable objects. Each tag is designed to transmit an Radio Frequency (RF) identification signal which cooperates with an RF unit. The RF unit is configured to receive the signal from any one of the tags and to identify from the signal the object to which the tag is attached. The tag may have a battery to provide the power to operate it. Alternatively, the tag may have a passive transponder which obtains power from an inductive pickup by an antenna on the transponder. The tag receives its energy by means of a charging signal which is generated by an RF circuit of the RF Unit, and picked-up by the tag's antenna. Other parts of the RF Unit act as a receiver and decode the information which is transmitted from the tag when charged. The tag may receive its charging signal and transmit its identification signal either simultaneously or at different phases during an operating cycle.

In the case of a milking or feeding parlor comprising a plurality of milking stalls, a separate antenna is positioned at each of the stalls. Each antenna is connected via a dedicated cable to an RF unit and a processor unit. A tag housing a transponder is affixed to each animal that is to enter the parlor, for example, on the animal's ear or leg. The RF unit energizes the transponder of the animal in the stall via the stall's antenna. The antenna receives the identification signal transmitted by the transponder in the stall and transmits it, to the processor.

U.S. Pat. No. 6,445,296 to Sadler, for example, discloses an identification system for use in animal feeding or milking parlors to identify which animal is in which stall of the parlor at a given time. An RF driver supplies current to an antenna in each stall. A stall's antenna emits power in the form of a time varying magnetic or electromagnetic field to energize a transponder affixed to an animal in the stall which transmits an identification signal. The driver and antenna are connected to a parallel inductor, which reduces the total inductance of the load seen by the driver.

### SUMMARY OF THE INVENTION

The present invention provides a system and method for the identification and location of moveable objects. The system of the invention may be used, for example, to identify an animal in a stall of a milking or feeding parlor. The system of the invention comprises one or more activators. Each activator is located at a different location, for example, in a different stall of an animal milking or feeding parlor. The system also comprises a plurality of identification tags each of which is adapted to be fixed to one of the movable objects to be identified. The system also comprises an identification module and a central processing unit having a receiver for receiving signals from the identification module. Each tag is configured to transmit a unique identification signal to the identification module. Each tag may have a battery operated transmitter. In a preferred embodiment, each tag contains a transponder that is activatable by a microreader, such as a TIRIS microreader, in the identification module.

The identification module has a transmitter for transmitting signals to the central processing unit. The transmitter may transmit, for example, at a frequency of 433 MHz. The identification module has a pick-up coil for receiving signals from the transmitter of an activator.

As stated above, each activator is located at a different location. The identification module is moveable from activator to activator and is preferably battery operated so as to be movable by an operator without any cable connections. In a preferred embodiment, the identification module is adapted to be strapped onto the wrist of a user.

In order to identify a movable object located in proximity to one of the activators, the identification module is placed in proximity to the activator. The identification module receives from the activator a signal identifying the activator. The identification module then transmits to the central processing unit a signal indicative of the identification of the activator, and hence indicative of the location of the object to be identified.

The identification module is then placed in proximity to the identification tag of the object to be identified. The identification module receives from the tag a signal identifying the tag, and hence identifying the object to which it is attached. The identity of the object is then transmitted by the identification module to the central processing unit. The processing unit stores the activator and object identifications in its memory.

The identification module may then be moved to an activator located at another location and the process repeated, so that at each location the identities of the location and the movable object at the location are determined and transmitted to the processor. For each location, the identity of the object at the location is stored in the memory.

This, in its first aspect, the invention provides a system for identification of a plurality of movable objects comprising:
(a) a plurality of activators, each activator capable of generating a unique first identification signal;
(b) a plurality of identification tags, each tag being adapted to be attached to one of the movable objects and capable of generating a unique second identification signal;
(c) a processor having a memory; and
(d) an identification module configured to:

(i) for each activator, receiving from the activator, the first identification signal and transmitting to the processor a first transmitted signal indicative of an identification of the activator; and

(ii) for each tag, receiving the second identification signal of the tag and transmitting to the processing unit a second transmitted signal indicative of an identification of the tag;

wherein the processor is configured, for each pair of a first transmitted signal and a second transmitted signal received from the identification module, to associate the identification of the activator with the identification of the tag and to store the identification of the activator and the identification of the tag in the memory.

In its second aspect, the invention provides a milking parlor or a feeding parlor comprising an identification system according to the invention.

In its third aspect, the invention provides a method for identifying a movable object from among a plurality of movable objects, the movable object being located at location, comprising
(a) Transmitting from an activator located at the location to an identification module a first identification signal identifying the activator;
(b) transmitting a first transmitted signal to a processor, the first transmitted signal being indicative of an identification of the activator;
(c) transmitting from a tag affixed to the object to the identification module a second identification signal identifying the tag;
(d) transmitting a second transmitted signal to the processor, the second transmitted signal being indicative of an identification of the tag; and
(e) storing the identification of the activator and the identification of the tag in a memory of the processor.

In its fourth aspect, the invention provides a tag for a limb of an animal comprising a hollow flexible cylindrical body having a first end and a second end, the first end clasping the second end when the body is brought into a torroidal shape.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows an identification system in accordance with one embodiment of the invention;

FIG. 2 shows an identification tag adapted to be affixed to an animal;

FIG. 3 is a plan view of a milking parlor comprising the identification system of FIG. 1; and

FIG. 4 shows use of the identification system of FIG. 1 to identify an animal in a stall of a milking parlor.

### DETAILED DESCRIPTION OF THE INVENTION

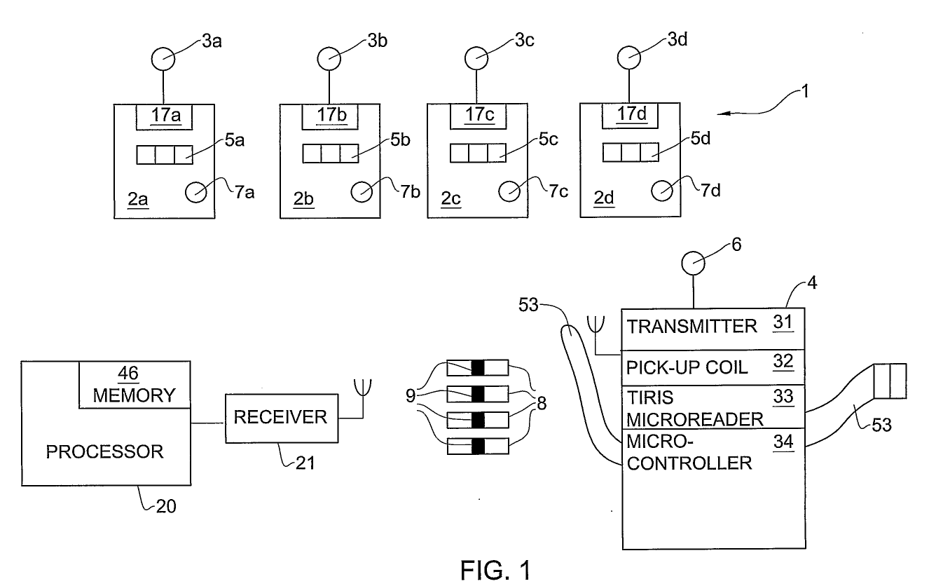

FIG. 1 shows schematically a system 1 for the identification of moveable objects in accordance with one embodiment of the invention. The system 1 comprises a plurality of activators 2. Four activators 2a to 2d are shown in FIG. 1. This is by way of example only, and the invention may be implemented with any number of activators. Each activator 2 further comprises a respective RF transmitter 17 and antenna 3, digital display 5 and start button 7. The system 1 further comprises an identification module 4, and a central processing unit 20. The system 1 also comprises a plurality of identification tags 8 that are adapted to be fixed to the movable objects to be identified. Each tag 8 contains a transponder 9 that is activatable by the identification module 4 as described below. When activated, a transponder transmits an RF identification signal to the identification module 4.

The central processing unit 20 has an associated memory 46 and includes a receiver 21 for receiving signals from the identification module 4, as described below.

The identification module 4 has a transmitter 31 for transmitting signals to the central processing unit 20. The transmitter may transmit, for example, at a frequency of 433 MHz. The identification module also has a pick-up coil 32 for receiving signals from a transmitter 17 of an activator 2, as described below. The identification module 4 also has a TIRIS microreader 33 for receiving RF signals from the transponders 9 located in the tags 8, so that the transponder 9 can be identified. Operation of the identification module 4 is under the control of a microcontroller 34.

The TIRIS microreader 33 has an antenna 6 comprising a coil of multicore wire and, in use, emits a time varying signal, for example, an oscillating magnetic field for energizing a pick-up coil of the transponders 9 of the tags 8, so that the transponder 9 can then emit its RF identification signal which is picked up by the antenna 6 of the identification module 4.

Use of the system 1 will now be described with reference to the identification of animals in stalls of a milking parlor. This is by way of example only, and the invention may be used to identify and locate movable objects within any context.

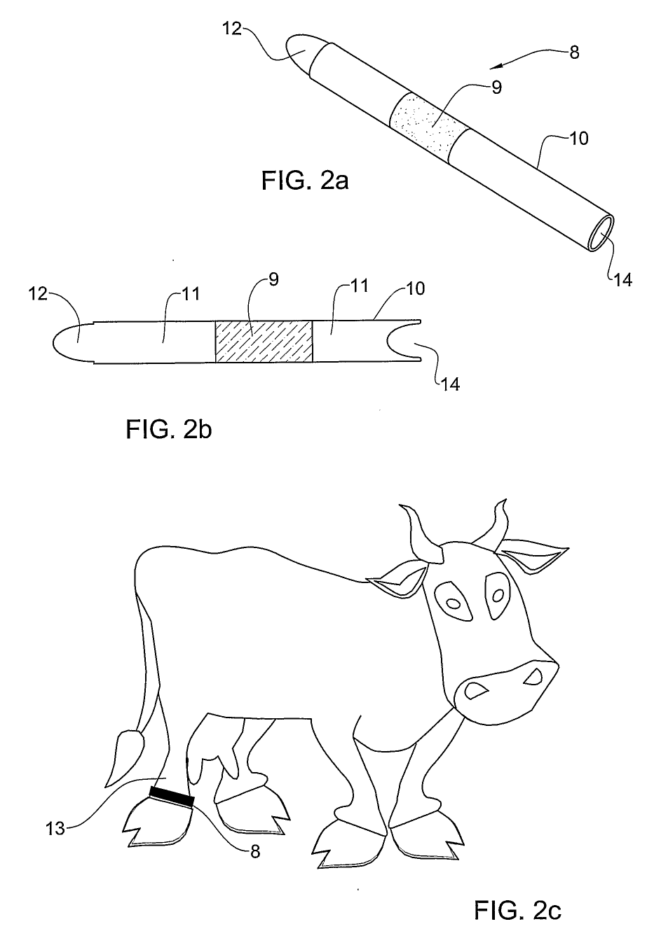

FIG. 2 shows an identification tag 8 adapted to be affixed as a bracelet on an animal's leg. This is by way of example only, and the tags 8 may be adapted to be affixed to any portion of the animals to be tagged, such as the animal's ear. The tag 8 is shown in a perspective view in FIG. 2a and in longitudinal section in FIG. 2b. The tag 8 comprises a hollow flexible cylindrical body 10 housing a transponder 9 in its interior 11. The body 10 may be made, for example, from rubber tubing having an outer diameter of about 10 mm and an inner diameter sufficient to receive the transponder 9. The body 10 has a male end 12 that clasps a female end 14 so that the flexible body 10 may be closed into a torroidal shape around an animal's leg 13, as shown in FIG. 2c. The length of the body 10 should thus be determined to allow the tag 8 to fit snugly around the leg 13 of the animal. For a goat or sheep, the length should be around 14 cm.

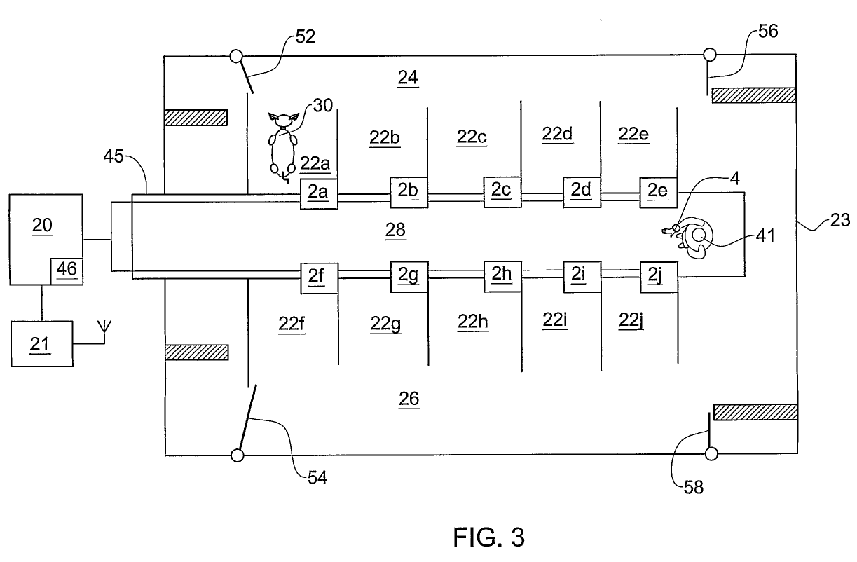

FIG. 3 shows a plan view of a milking parlor 23 in which the system 1 has been installed. The milking parlor 23 has a plurality of milking stalls 22 arranged in two rows which are situated on either side of a central operator's pit 28. Access to each row of stalls is gained via a respective one of a pair of corridors 24 and 26. In use, animals pass through either one of two entry gates 52 and 54, each animal then being urged to enter into one of the milking stalls 22 with its rear end closest to the operator pit 28, as shown for the animal 30 in the stall 22a. After milking, the animals leave the stalls 22 and exit the parlor through exit gates 56 and 58.

Each stall 22 also contains a respective activator 2 identical to the activator 2 shown in FIG. 1. Each activator 2 is connected via a communication line 45 to the central processor 20. The identification module 4 is moveable from stall to stall in the milking parlor, and is preferably battery operated so as to be movable from stall to stall by an operator in the operator pit without any cable connections. In a preferred embodiment, the identification module 4 is adapted to be strapped onto the wrist of an operator 41, by means of straps 53 (see FIG. 1), as shown in FIG. 3.

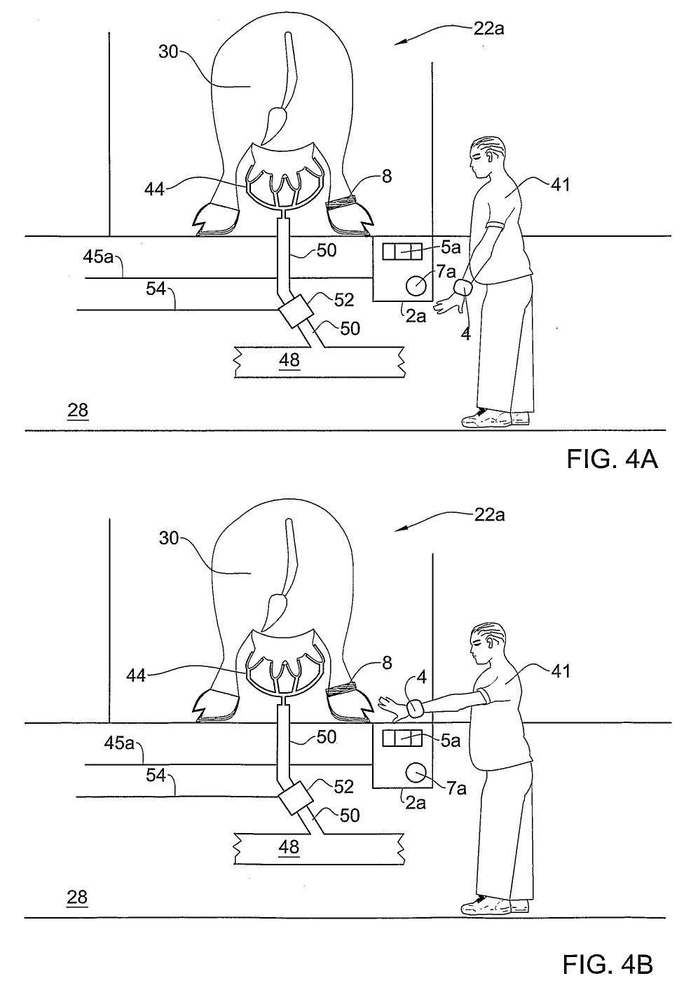

FIG. 4 shows use of the system 1 to identify the animal 30 in the stall 22a. As shown in FIG. 4a, the identification module 4 is placed in proximity to the activator 2a of the stall 22a. The user presses the start button 7 on the activator 2a. The activator 2a then activates the TIRIS microreader 33 in the identification module 4, which was previously in a stand-by mode in order to conserve power. The pick up coil 32 of the identification module 4 receives from the activator 2a a signal identifying the activator 2a. The transmitter 31 of the identification module 4 then transmits to the central processing unit 20 via the receiver 21 a signal indicative of the identification of the activator 2a. The central processing unit 20 then transmits to the activator 22a over the line 45a a signal confirming receipt of the activator's identity. Receipt by the activator of the confirmation by the activator may be indicated, for example, by indicating the activator's identity on the digital display 5a of the activator 2a. Pressing the start button 7 of the activator 2a also activates a milking apparatus 44 of the stall 22a, and milking of the animal 30 commences.

Then, as shown in FIG. 4b, the identification module 4 is placed in proximity to the identification tag 8 of the animal 30 in the stall 22a. The TIRIS microreader 30 of the identification module 4 activates the transponder 9 of the activation tag 8, and receives from the transponder a signal identifying the animal in the stall. The identity of the animal in the stall is then transmitted by transmitter 31 of the identification module 4 to the central processing unit 20 via the receiver. 21. The processing unit stores the stall and animal identifications in the memory 46.

Milk collected from the animal 30 flows from a milking apparatus 44 to a collecting pipe 48 via a connecting tube 50. A milk analyzer 52 in proximity to the connecting tube 50 analyzes the milk as it flows in the connecting tube 50, for example, with respect to its mass and/or conductivity. Data relating to the milk collected by the analyzer are transmitted to the central processing unit 21 via a communication line 54 which also identifies the stall 2a at which the milk was collected. The processor 20 associates the identification of the animal 30 with the identification of the stall 2a and with the data relating to the milk collected at stall 22a and stores the identities of the stall 22a and the animal 30 and the data relating to the milk collected from the animal 30 in the memory 46.

The identification module 4 may then be moved to another stall and the process repeated with the same identification module, so that at each stall the identities of the animal and the stall are determined and transmitted to the central processor 20. For each stall, the identity of the animal and the stall are stored in the memory 46 together with data relating to the milk colleted from the animal in the stall.

1. A system for identification of a plurality of movable objects comprising:
(a) a plurality of activators, each activator capable of generating a unique first identification signal;
(b) a plurality of identification tags, each tag being adapted to be attached to one of the movable objects and capable of generating a unique second identification signal;
(c) a processor having a memory; and
(d) an identification module configured to:
(i) for each activator, receiving from the activator, the first identification signal and transmitting to the processor a first transmitted signal indicative of an identification of the activator; and
(ii) for each tag, receiving the second identification signal of the tag and transmitting to the processing unit a second transmitted signal indicative of an identification of the tag;
wherein the processor is configured, for each pair of a first transmitted signal and a second transmitted signal received from the identification module, to associate the identification of the activator with the identification of the tag and to store the identification of the activator and the identification of the tag in the memory.

2. The system according to claim 1 wherein the identification module comprises any one or more components selected from:
(a) a transmitter configured to transmit signals to the processor;
(b) a pick-up coil;
(c) a microreader; and
(d) a micro-controller.

3. The system according to claim 2 wherein the microreader is a TIRIS microreader.

4. The system according to claim 1 wherein the identification module is battery operated.

5. The system according to claim 1 wherein the identification module is adapted to be affixed to the body of a user.

6. The system according to claim 5 wherein the identification module is adapted to be affixed to a user's wrist.

7. The system according to claim 2 wherein the transmitter is an RF transmitter.

8. The system according to claim 1 wherein one or more of the activators comprises any one or more components selected from:
(a) a transmitter transmitting a signal identifying the activator to the identification module;
(b) a start button; and
(c) a display.

9. The system according to claim 1 wherein one or more of the tags comprises a battery operated transceiver;

10. The system according to claim 1 wherein one or more of the tags comprises a transponder.

11. The system according to claim 9 wherein one or more of the tags comprises a hollow cylindrical body housing a transponder.

12. The system according to claim 1 wherein the processor is further configured to send a signal to an activator confirming receipt of a first transmitted signal from the identification module identifying the activator.

13. The system according to claim 1 wherein
(a) the identification module comprises a first transmitter configured to transmit signals to the processor, a pick-up coil configured to receive signals from the activator; and a microreader;
(b) each activator comprises a second transmitter configured to transmit an identification signal identifying the activator to the identification module; and
(c) each tag comprises a transponder activatable by the microreader of the and configured to transmit, when activated, an identification signal identifying the tag to the identification module.

14. The system according to claim 13 wherein the microreader is a TIRIS microreader.

15. The system according to claim 13 wherein the first and second transmitters are RF transmitters.

16. The system according to claim 1 wherein the moveable object is an animal.

17. The system according to claim 1 wherein the tags are adapted to be affixed to an animal's leg or ear.

18. The system according to claim 17, wherein the tags are adapted to be affixed around an animal's leg.

19. The system according to claim 18 wherein each tag comprises a hollow cylindrical body housing a transponder, the body having a first end and a second end, the first and second ends adapted for mating with each other when the body is brought to a torroidal shape.

20. A milking parlor or a feeding parlor comprising an identification system according to claim 1.

21. The milking parlor or feeding parlor according to claim 19 wherein each activator is positioned in a different stall of the parlor.

22. A method for identifying a movable object from among a plurality of movable objects, the movable object being located at location, comprising
(a) Transmitting from an activator located at the location to an identification module a first identification signal identifying the activator;
(b) transmitting a first transmitted signal to a processor, the first transmitted signal being indicative of an identification of the activator;
(c) transmitting from a tag affixed to the object to the identification module a second identification signal identifying the tag;
(d) transmitting a second transmitted signal to the processor, the second transmitted signal being indicative of an identification of the tag; and
(e) storing the identification of the activator and the identification of the tag in a memory of the processor.

23. A tag for a limb of an animal comprising a hollow flexible cylindrical body having a first end and a second end, the first end clasping the second end when the body is brought into a torroidal shape.

24. The tag according to claim 23 wherein the tag comprises a battery operated transceiver located in a lumen of the body.

25. The tag according to claim 24 wherein the tag comprises a transponder located in a lumen of the body.
